(19) United States
(12) Patent Application Publication
(10) Pub. No.: US 2018/0343317 A1
(43) Pub. Date: Nov. 29, 2018

(54) Discovery Of Network Device Roles Based On Application Level Protocol Parsing In Organizational Environments

(71) Applicant: Microsoft Technology Licensing, LLC, Redmond, WA (US)

(72) Inventors: Benny LAKUNISHOK, Holon (IL); Sivan KRIGSMAN, Hertzliya (IL)

(21) Appl. No.: 15/606,783

(22) Filed: May 26, 2017

(51) Int. Cl. H04L 29/08; H04L 12/751; H04L 29/12

(52) U.S. Cl. CPC H04L 67/303; H04L 29/06; H04L 61/35; H04L 45/02

(57) ABSTRACT

A system includes a data collector to collect first information from traffic monitored by a gateway. An IP resolver resolves addresses to device names using the first information. The device names are associated with respective ones of a plurality of devices. Resolving the IP addresses includes identifying which of the device names was assigned each of the IP addresses. An IP address profiler generates IP address profiles for the IP addresses. The IP address profiles include second information identifying which of the device names were assigned which of the IP addresses in a login session and at least one characteristic of the login session. The data collector collects third information from one of the IP address profiles. A device role resolver uses the third information to determine a role of a first device that is associated with a first device name and store fourth information identifying the determined role.

### CROSS-REFERENCE TO RELATED APPLICATIONS

The present application is related to U.S. patent application Ser. No. 15/425,702, filed on Feb. 6, 2017, which claims the benefit of U.S. Provisional Application No. 62/408,014, filed on Oct. 13, 2016. The entire disclosures of the applications referenced above are incorporated by reference.

### FIELD

The present disclosure relates to discovery network device roles in a distributed network system.

### BACKGROUND

The background description provided herein is for the purpose of generally presenting the context of the disclosure. Work of the presently named inventors, to the extent the work is described in this background section, as well as aspects of the description that may not otherwise qualify as prior art at the time of filing, are neither expressly nor impliedly admitted as prior art against the present disclosure.

In a distributed network system (e.g., of a corporate enterprise), a plurality of entities such as client devices, servers, etc. communicate with each other and with one or more central servers over a network. For example, the distributed network system may provide distributed data storage, application hosting and processing, and other services to various remote or local entities. Accordingly, a central server may interface with a large number of devices attempting to access the distributed network system.

### SUMMARY

A system includes a gateway to monitor traffic from a plurality of devices accessing a network. A data collector is to collect first information from the traffic monitored by the gateway. An Internet Protocol (IP) resolver is to resolve addresses to a plurality of device names using the collected first information. Each of the plurality of device names is associated with a respective one of the plurality of devices, and resolving the IP addresses includes identifying which of the plurality of device names was assigned each of the IP addresses. An IP address profiler is to generate respective IP address profiles for each of the IP addresses. Each of the IP address profiles includes second information identifying which of the plurality of device names were assigned a respective one of the IP addresses in a login session and at least one characteristic of the login session. The data collector is further to collect third information from at least one of the IP address profiles. A device role resolver is to, using the third information collected from the at least one of the IP address profiles, determine a role of a first device of the plurality of devices that is associated with a first device name of the plurality of device names and store fourth information identifying the determined role of the first device.

A method includes monitoring traffic from a plurality of devices accessing a network, collecting first information from the monitored traffic, and resolving Internet Protocol (IP) addresses to a plurality of device names using the collected first information. Each of the plurality of device names is associated with a respective one of the plurality of devices, and resolving the IP addresses includes identifying which of the plurality of device names was assigned each of the IP addresses. The method further includes generating respective IP address profiles for each of the IP addresses. Each of the IP address profiles includes second information identifying which of the plurality of device names were assigned a respective one of the IP addresses in a login session and at least one characteristic of the login session. The method further includes collecting third information from at least one of the IP address profiles, determining a role of a first device of the plurality of devices that is associated with a first device name of the plurality of device names using the third information collected from the at least one of the IP address profiles, and storing fourth information identifying the determined role of the first device.

A gateway for a distributed network system includes a processor and a tangible machine readable medium storing machine readable instructions that, when executed by the processor, configure the gateway to monitor traffic from a plurality of devices accessing the distributed network system, collect first information from monitored traffic, and resolve Internet Protocol (IP) addresses to a plurality of device names using the collected first information, wherein each of the plurality of device names is associated with a respective one of the plurality of devices. Resolving the IP addresses includes identifying which of the plurality of device names was assigned each of the IP addresses. The instructions further configured the gateway to generate respective IP address profiles for each of the IP addresses, each of the IP address profiles including second information identifying which of the plurality of device names were assigned a respective one of the IP addresses in a login session and at least one characteristic of the login session, collecting third information from at least one of the IP address profiles, determine a role of a first device of the plurality of devices that is associated with a first device name of the plurality of device names using the third information collected from the at least one of the IP address profiles, and store fourth information identifying the determined role of the first device. A profile database stores the IP address profiles and the fourth information identifying the determined role of the first device.

Further areas of applicability of the present disclosure will become apparent from the detailed description, the claims and the drawings. The detailed description and specific examples are intended for purposes of illustration only and are not intended to limit the scope of the disclosure.

### BRIEF DESCRIPTION OF DRAWINGS

FIG. 1A is an example distributed network system that implements key-value systems and methods according to the principles of the present disclosure.

FIG. 1B is an example client device that implements key-value systems and methods according to the principles of the present disclosure.

FIG. 1C is an example server that implements key-value systems and methods according to the principles of the present disclosure.

FIG. 2 is an example network according to the principles of the present disclosure.

FIG. 3 illustrates steps of an example method for resolving IP addresses to device names according to the principles of the present disclosure.

FIG. 4 illustrates steps of an example method for determining IP addresses assigned to device names according to the principles of the present disclosure.

FIG. 5 is an example security monitor or center according to the principles of the present disclosure.

FIG. 6 is an example IP address profile according to the principles of the present disclosure.

FIG. 7 is an example device name profile according to the principles of the present disclosure.

FIG. 8 illustrates steps of an example method for resolving a role of a device associated with a device name according to the principles of the present disclosure.

In the drawings, reference numbers may be reused to identify similar and/or identical elements.

### DESCRIPTION

In a distributed network system (e.g., a cloud computing system of a corporate enterprise), a plurality of entities such as client devices, servers, etc. communicate with each other and with one or more central servers over a network. For example, the distributed network system may provide distributed data storage, application hosting and processing, and other services to various remote or local entities. Accordingly, a central server may interface with a large number of devices attempting to access the distributed network system.

The central server may implement a security monitor or center configured to locate and identify users and devices accessing the distributed network system. For example, in a network using Transmission Control Protocol/Internet Protocol (TCP/IP), an IP address may be converted or resolved to an actual host or device name. However, since IP addresses are dynamic, an IP address that may correspond to a device at a given time may not correspond to that same device at a later time. Further, login credentials of a valid user may be compromised by an unauthorized user (e.g., a hacker). If the unauthorized user accesses the distributed network system using the login credentials, an additional IP address becomes associated with the valid user.

Accordingly, resolving IP addresses to names of specific devices and associated users may be indicative of a type of device (e.g., a role of the device) used to access the distributed network system. For example, devices may include, but are not limited to, mobile devices, servers, personal computers (PCs), etc., and the devices may access the distributed network system using various connection types (e.g., wired or wireless connections). Device role discovery systems and methods according to the principles of the present disclosure monitor traffic to determine roles of devices accessing the distributed network system. For example, characteristics of IP addresses assigned to a particular user may indicate a type and/or role of the corresponding device. In some examples, characteristics of IP addresses that may be indicative of roles of devices may include, but are not limited to, a duration that a respective IP address is assigned to a particular device or user, a number of users associated with a same IP address over a given period, a number of IP addresses assigned to a user or device, etc.

Below are simplistic examples of a distributed computing environment in which the systems and methods of the present disclosure can be implemented. Throughout the description, references to terms such as servers, client devices, applications and so on are for illustrative purposes only. The terms servers and client devices are to be understood broadly as representing computing devices comprising one or more processors and memory configured to execute machine readable instructions. The terms applications and computer programs are to be understood broadly as representing machine readable instructions executable by the computing devices.

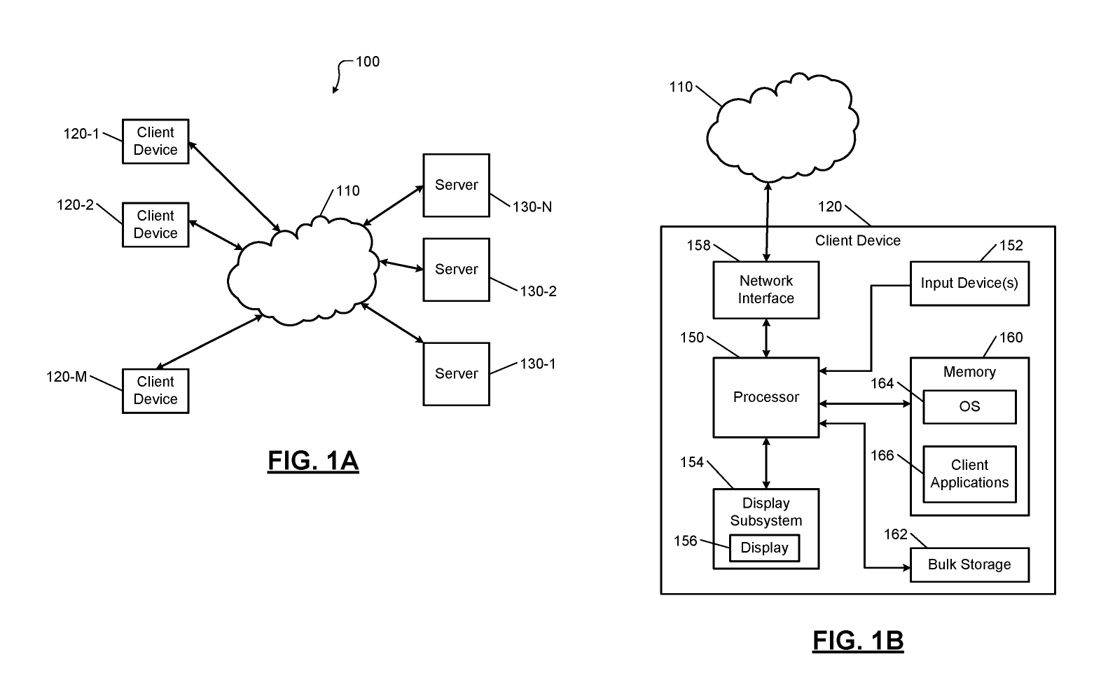

FIG. 1A shows a simplified example of a distributed network system 100 implementing the device role discovery systems and methods of the present disclosure. The distributed network system 100 includes a network 110, one or more client devices 120-1, 120-2, . . . , and 120-M (collectively client devices 120), and one or more servers 130-1, 130-2, . . . , and 130-N (collectively servers 130). The network 110 may include a local area network (LAN), a wide area network (WAN) such as the Internet, or other type of network (collectively shown as the network 110). For example, the servers 130 may be located at different departments and different geographical locations of an enterprise. The client devices 120 communicate with one or more of the servers 130 via the network 110. The client devices 120 and the servers 130 may connect to the network 110 using wireless and/or wired connections to the network 110.

For example, the client devices 120 may correspond to remote and/or local devices and include smartphones, personal digital assistants (PDAs), laptop computers, personal computers (PCs), file servers, and so on. The servers 130 may provide multiple services to the client devices 120. For example, the server 130 may execute a plurality of software applications developed by one or more vendors. The servers 130 may host multiple databases that are utilized by the plurality of software applications and that are used by users of the client devices 120.

Each of the client devices 120 may be associated with a particular device type, connection type (e.g., wired or wireless), function, etc., which may be referred to as a “role” of the client device 120. For example only, roles may include, but are not limited to, network address translation (NAT) devices (i.e., a topology where multiple devices share a same IP address), virtual private network (VPN) devices, Wifi or other wireless connections, Ethernet or other wired connections, etc., and/or combinations thereof. Generally, the client devices 120 are assigned an IP address when connecting to and accessing the distributed network system 100. Accordingly, over time, each IP address within the distributed network system 100 may be associated with different ones of the client devices 120, different users, etc. Further, each of the client devices 120 may be associated with a respective device name to identify each of the client devices 120 within the distributed network system 100.

One or more of the servers 130 (or, in some examples, the network 110 itself) may correspond to a central server that implements a security monitor or center according to the principles of the present disclosure. For example, the security center is configured to monitor device names associated with each IP address and classify device roles based on the monitored IP addresses and device names as described below in more detail.

FIG. 1B shows a simplified example of one of the client devices 120. The client device 120 may typically include a central processing unit (CPU) or processor 150, one or more input devices 152 (e.g., a keypad, touchpad, mouse, and so on), a display subsystem 154 including a display 156, a network interface 158, a memory 160, and a bulk storage 162.

The network interface 158 connects the client device 120 to the distributed network system 100 via the network 110. For example, the network interface 158 may include a wired interface (e.g., an Ethernet interface) and/or a wireless interface (e.g., a Wi-Fi, Bluetooth, near field communication (NFC), or other wireless interface). The memory 160 may include volatile or nonvolatile memory, cache, or other type of memory. The bulk storage 162 may include flash memory, a hard disk drive (HDD), or other bulk storage device.

The processor 150 of the client device 120 executes an operating system (OS) 164 and one or more client applications 166. The client applications 166 include an application to connect the client device 120 to one or more of the servers 130 via the network 110. The client device 120 accesses one or more applications executed by the servers 130 via the network 110. The client device 120 connects to and accesses the servers 130 in accordance with an IP address assigned by the network 110.

FIG. 1C shows a simplified example of one of the servers 130. The server 130 typically includes one or more CPUs or processors 170, one or more input devices 172 (e.g., a keypad, touchpad, mouse, and so on), a display subsystem 174 including a display 176, a network interface 178, a memory 180, and a bulk storage 182.

The network interface 178 connects the server 130 to the distributed network system 100 via the network 110. For example, the network interface 178 may include a wired interface (e.g., an Ethernet interface) and/or a wireless interface (e.g., a Wi-Fi, Bluetooth, near field communication (NFC), or other wireless interface). The memory 180 may include volatile or nonvolatile memory, cache, or other type of memory. The bulk storage 182 may include flash memory, one or more hard disk drives (HDDs), or other bulk storage device.

The processor 170 of the server 130 executes an operating system (OS) 184 and one or more server applications 186. The bulk storage 182 may store one or more databases 188 that store data structures used by the server applications 186 to perform respective functions. In examples where the server 130 corresponds to a central server, the network interface 178, the processor 170, the memory 184, and/or one or more of the server applications 186 may correspond to or implement a security center according to the principles of the present disclosure, as described below in more detail.

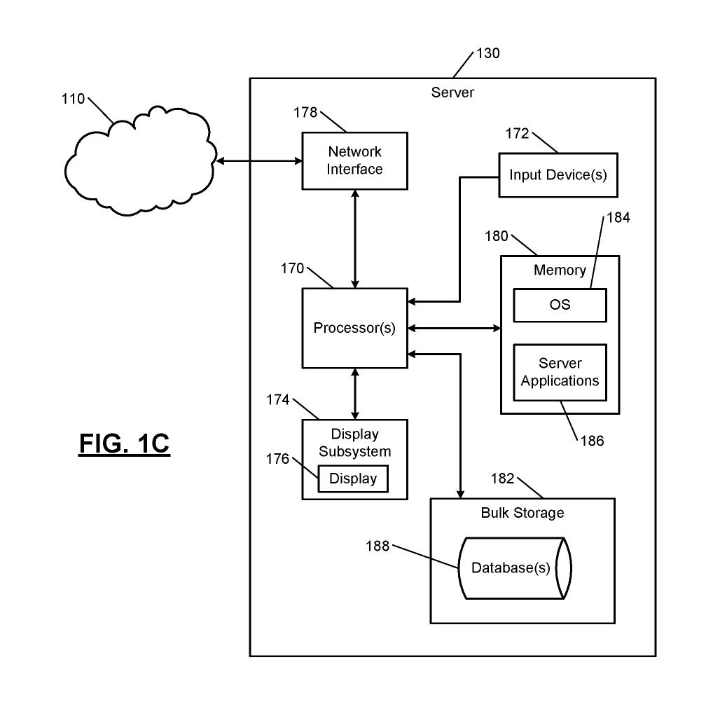

FIG. 2 shows an example distributed network system 200 according to the principles of the present disclosure. An enterprise such as an enterprise network 210 may be distributed across a plurality of sites 220-1, 220-2, . . . , and 220-P, collectively sites 220. The sites 220 may be accessed by one or more of devices 224-1, 224-2, . . . , 224-M, collectively remote devices 224, which may be located remotely (i.e., externally) relative to the network 210 and/or the sites 220. The sites 200 may further be accessed by one or more of local devices 228-1, 228-2, . . . , 228-N, collectively local devices 228, which may be located locally (i.e., internally) relative to the network 210 and/or the sites 220. The remote devices 224 and the local devices 228, which may correspond to the client devices 120 described in FIGS. 1A and 1B, are operated by users. A “user” may correspond to an individual, an automated system (e.g., a bots), etc. that requests connections to one or more of the sites 220 of the network 210.

The network 210 provides an operating environment that allows computing devices distributed across a plurality of the sites 220 and domains to interact to interact with the each other and with the network 210. For example, the remote devices 224 and the local devices 228 may correspond to devices of a company, a governmental agency, an educational institution, etc. distributed across a large geographical area. Each of the sites 220 may include a gateway 232, a network service provider 236 in communication with the gateway 232, and a security monitor or center 240, which may be referred to simply as a center 240. The network service provider 236 is configured to authenticate entities (i.e., users, devices, etc.) attempting to access the network 210. The center 240 is configured to aggregate connection information from the remote devices 224 to manage entity location data.

The gateway 232, the network service provider 236, and the center 240 may each include hardware devices and software running on those devices to provide the functionalities thereof. In some examples, the gateway 232 may be executed on dedicated hardware or may be provided via software on a computing device used for several purposes, such as, for example, on the same hardware as the network service provider 236. In some examples, the network 210 may implement fewer of the centers 240 than the sites 220 (i.e., two or more of the sites 220 may share the same center 240). For example only, as shown in FIG. 2, one or more of the gateway 232, the network service provider 236, and the center 240 are implemented on a same server 244, which may correspond to a central server. In other examples, each of the gateway 232, the network service provider 236, and the center 240 may be implemented on different servers and/or hardware devices.

To provide access to the network 210, the network service provider 236 of a respective site 220 authenticates the remote devices 224 and the local devices 228. For example, the remote devices 224 may connect to the site 220-1 via a VPN connection or other tunnel to initiate a session, whereas the local devices 228 connect to the site 220-1 corresponding to their respective locations. A type of connection to the network 210 determines whether a given device is a remote device 224 or a local device 228. In some examples, a device may be both a remote device 224 and a local device 228. For example, in a first session, a user may connect locally to the network 210 using a local device 228 while at the site 220-1 (e.g., in an office or other local work environment) and also use the same device at another location external to the site 220-1 (e.g., home) to access the enterprise 210 in a second session. Accordingly, the device accesses the network 210 as a remote device 130 in the second session. Each time an entity (e.g., a specific device, a specific user, etc.) connects to a given one of the sites 220, the network service provider 236 and/or the gateway 232 store data indicative of the connections. For example, the network service provider 236 and/or the gateway 232 may store data mapping (i.e., indexing) each connection to a device name, a user of the device, an IP address assigned to the device name for that connection, etc.

During a session, the network service provider 236 receives network packets from the devices 224 and 228, and replicates and communicates the network packets to the gateway 232. The gateway 232 monitors information in the network packets such as network address information corresponding to the devices 224 and 228. For example, each time a user (e.g., as identified by an associated user account) logs into the site 220-1 and establishes a session on the network 110, the gateway 232 may store the network address information associated with the login request, which may include an IP address assigned to the user and the associated device.

The gateway 232 may also monitor and log connection attempts and activity sessions of the local devices 228. In some examples, the local devices 228 are associated with IP addresses internal to the network 210. Internal IP addresses may be masked for use within the network 210 and may be inconsistent for a given device. The gateway 232 monitors the entities associated with the login and session (e.g., the user account and devices) and assigns a location (e.g., a calculated or physical location) of the corresponding site 220 to the entity at the time of login.

In some examples, the gateway 232 selectively stores information related to connection attempts rejected by the network service provider 124 (e.g., connection attempts that were rejected for an incorrect username or password). For example, the gateway 232 may store and use (i.e., use along with data aggregated from remote connection sessions), store and filter (i.e., store without using), and/or exclude from storage information related to the rejected connection attempts. Similarly, the gateway 232 may selectively store and filter (or block from storage) connection attempts received from a list of addresses that are associated with blocked parties, unreliable geolocation, a duration or number of connections meeting an unreliability threshold (e.g., an unstable connection indicated by multiple short connections). Accordingly, connection attempts that did not result in an IP address being assigned to an entity and a successful login session may be filtered out or ignored.

The network service provider 236 selectively accepts communications from and establishes sessions with the devices 224 and 228 attempting to access the network 210. Conversely, the gateway 232, communicating with the network service provider 236, collects and aggregates connection information from the devices 224 and 228 accessing the network 210. In some examples, all or part of the collected information may correspond to tunneled traffic from the remote devices 224 connected to network 210 via a VPN (or other tunnel connection) allowing users to access network services.

As described herein, one or more of the gateway 232, the network service provider 236, and the center 240 may collectively be referred to as a network name resolver (NNR) 248. For example, the NNR 248 is configured to determine, using the collected network traffic information, IP addresses for the devices 224 and 228 accessing the network 210. In one example, an IP address is determined by actively querying a respective one of the devices 224 and 228. Accordingly, one or more requests are sent (e.g., via network packets utilizing one or more protocols) to the devices 224 and 228 and, if a response is received, the IP address is determined using network information in the provided response. For example, in some protocols, an IP address is identified in a header or other field of a data packet.

In other examples (e.g., instead of or in addition to actively sending a request to the devices 224 and 228), the NNR 248 may determine the IP address from network traffic collected from the devices 224 and 228 using other information available in various network communication protocols. For example, some protocols may implement an authentication protocol including an exchange of authentication packets. Accordingly, the NNR 248 may determine whether network traffic corresponds to a particular device using information in the authentication packets. For example, when monitoring traffic from the devices 224 and 228, the gateway 232 is configured to determine when a user is actively on one of the devices 224 and 228 and, therefore, to also determine the corresponding IP address upon authenticating each login. Suitable protocols may include, but are not limited to, a LAN Manager (e.g., an NT LAN Manager, or NTLM) protocol, Kerberos, Lightweight Directory Access Protocol (LDAP), Network Time Protocol (NTP), etc.

The NNR 248 (e.g., the center 240 and/or the gateway 232) may implement memory, such as a cache, for storing results of the IP address determination. For example, the results may correspond to a table, index, etc. of the IP addresses and corresponding information. The cache may be updated with a current state of the IP addresses (e.g., assigned, unassigned, duration of current session, etc.) that are discovered and subsequently accessed by the NNR 248 to determine which IP addresses have been identified. The NNR 248 also resolves each IP address respective names of the devices 224 and 228. For example, a first IP address may initially be resolved to a first device name corresponding to a first one of the devices 224 and 228. The first IP address may subsequently be resolved to a second device name corresponding to a second one of the devices 224 and 228. Accordingly, the first IP address is assigned to two or more different ones of the devices 224 and 228 over time and the stored results are updated accordingly.

In some examples, the center 240 generates a respective profile for each of the IP addresses. The profiles include information identifying the devices names that have been associated with a respective IP address over time. Accordingly, each profile is updated to identify the IP address, the plurality of device names assigned the IP address, etc.

Each device name that is resolved to a particular IP address (i.e., resolved device name) may be timestamped with a specific time the NNR 248 resolved the device name. Accordingly, the stored results, profiles, etc. further indicate how often an IP address was assigned to different ones of the devices 224 and 228, a number of different device names that resolved to the same IP address, etc. For example, “high substitution” IP addresses may be determined by counting the number of different device names assigned the same IP address. The number of device name changes is sometimes referred to as a number of “invalidations” or an “invalidation count.” If the number of invalidations reaches a predetermined threshold within a predetermined period, the IP address may be identified as a high substitution IP address.

Using the stored profiles, the NNR 248 (and/or IT specialists, other processes implemented on the network 210, etc.) is able to identify when a device name associated with a particular IP address changes. For example, the NNR 248 or other entity may periodically and/or conditionally query a particular profile. Accordingly, a device name associated with an IP address may be determined for any given time period. In some examples, each profile may be structured as a timeline or timetable of device names that are assigned a respective IP address.

Because IP address are dynamic, subsequent resolving of the same IP addresses may result in the profiles being updated with additional device names. Further, each repeated resolution of an IP address may result in the same or different device names being associated with the IP address. Further, a second IP address may be resolved to the same or other device names as a first IP address. Accordingly, different profiles can be queried to identify different device names that were assigned different IP addresses, and whether a same device name was assigned different IP addresses during respective periods. For example, each period may correspond to all or a portion of a day or all or a portion of several days. Further, the period may correspond to a single login session or a plurality of login sessions. In some examples, a profile may include information corresponding to more than one resolved IP address. For example, a profile may include multiple IP addresses (e.g., both the first and second IP addresses) resolved to a same device.

In some examples, a queried profile may be generated and displayed on a user interface illustrating the resolved device names and (e.g., with or without the corresponding IP address). For example, if all or portions of the NNR 248 are implemented on a server, the user interface may correspond to a display 176 of a server 130 as described with respect to FIG. 1C, on a display 156 of a device 120 used by an IT specialist as described with respect to FIG. 1B, etc. All or only specific portions of a profile may be selected for display. In some examples, the profile may include a line, pie, or bar graph, a histogram, etc. indicating the various device names for one or more resolved IP addresses over time. The displayed profile may also indicate a length of time each device name was associated with a particular IP address. The profile may indicate whether the IP address was actively queried, which authentication protocol was used to identify the IP address, etc. The profile may also indicate specific ones of the devices 224 and 228 that one or more users recently logged onto and any resources, services, etc. that were accessed in the corresponding sessions.

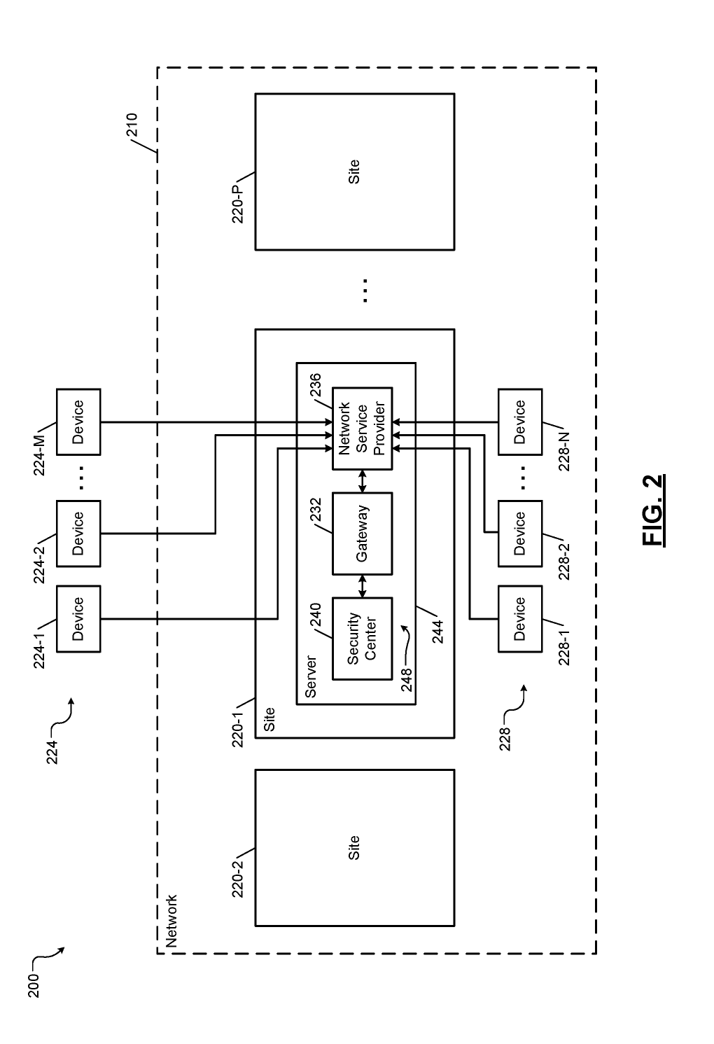

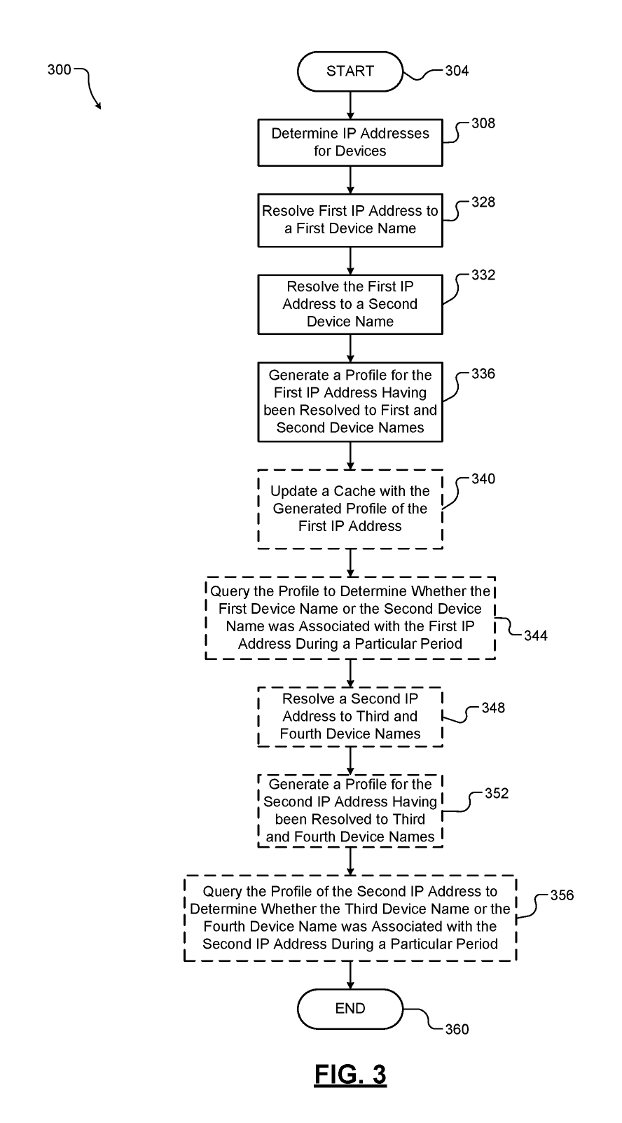

Referring now to FIGS. 3 and 4, an example method 300 for resolving IP addresses to device names begins at 304. At 308, the method 300 (e.g., the NNR 248) determines IP addresses for devices (e.g., the devices 224 and 228) accessing a network 210. The determining of IP addresses at 308 is described in more detail in FIG. 4. At 312, the method 300 collects traffic from the devices 224 and 228. For example, the traffic is collected by the gateway 232 via replication from the network service provider 236. At 316, the method 300 may query one or more of the devices 224 and 228 to determine IP addresses. In some examples, the method 300 performs both collecting of network traffic and querying of the devices 224 and 228 to determine IP addresses. However, in other examples, the method 300 may perform only one of collecting network traffic and querying the devices 224 and 228 to determine IP addresses. At 320, the method 300 determines the IP address using at least one of the collected traffic and a response to the querying. At 324, the method 300 continues to 328 in FIG. 3.

At 328, the method 300 resolves a first IP address to a first device name. At 332, the method 300 resolves the first IP address to a second device name. At 336, the method 300 generates a profile of the first IP address indicating that the first IP address was resolved to both the first device name and the second device name.

The method 300 may include one or more optional steps. For example, at 340, the method 300 updates stored information (e.g., cache or other memory) with the generated profile. At 344, the method 300 queries the profile of the first IP address to determine whether the first device name or the second device name was associated with the first IP address during particular period. At 348, the method 300 resolves a second IP address to a third device name and a fourth device name. At 352, the method 300 generates a profile for the second IP address indicating that the second IP address was resolved to both the third device name and the fourth device name. At 356, the method 300 queries the profile of the second IP address to determine whether the third device name or the fourth device name was associated with the second IP address during a particular period. The method 300 ends at 360.

One or more components of the NNR 248 according to the principles of the present disclosure may further implement a device role resolver (DRR) configured to determine and classify a respective role of each of the devices 224 and 228 using the collected information, including the profiles indicating resolution of IP addresses to various devices and device names. For example, information stored in the IP address profiles may be further indicative of types, roles, etc. of devices used to access the network 210 as described below in more detail.

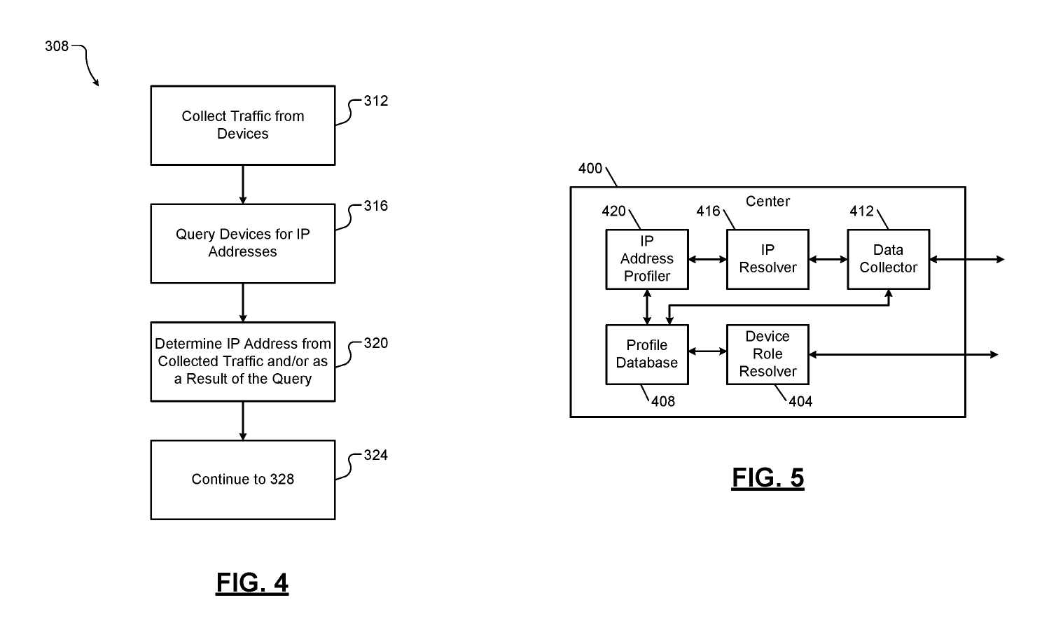

Referring now to FIG. 5, an examiner security monitor or center 400, which may be referred to as the center 400, is shown to include a DRR 404 and a profile database 408. For example, the profile database 408 may correspond to cache memory as described above and may include other forms of volatile and/or non-volatile memory. Although shown within the center 400 for example purposes, the DRR 404 may be implemented within one or more of the center 400, the gateway 232, the network service provider 236, etc. The DRR 404 may correspond to hardware executing one or more applications related to functions of the DRR 404 as described below, such as the processor 170 executing one or more DRR server applications 186 stored in the memory 180 as shown in FIG. 1C.

The profile database 408 stores the profiles generated for the IP addresses as described above, and may store other information collected from network traffic. In this example, each of the profiles corresponds to one or more of the IP addresses and includes information (e.g., a table, index, etc. including a plurality of respective fields or columns) correlating each of the IP addresses to device names, users, etc. In other words, the profiles indicate the device names (and, in some examples, respective users) that each IP address was assigned to over time. The profiles indicate a specific first time that the IP address was assigned to a particular device name (e.g., via a timestamp generated during initialization of a session), and may further indicate a second time that a session ended. In some examples, the profile may further indicate a duration of a session (i.e., a duration that the IP address was assigned to a particular device name), and/or an entity such as the DRR 404 may calculate the duration using the first time and the second time, for example. In examples where a session is still ongoing (i.e., an IP address is still assigned to a device name), the profile may be periodically updated to indicate the current duration.

Similarly, the profile may also indicate a first number of times the IP address was assigned to a particular device name over a predetermined period of time, a second number of times the IP address was assigned to any device name over a predetermined period of time, a number of different devices the IP address was assigned to over a predetermined period of time, etc. Alternatively or additionally, the DRR 404 may calculate the first number of times, the second number of times, the number of devices, etc. In other words, the profile may include fields including values such as the duration, the first number of times, the second number of times, the number of devices, etc., and/or the DRR 404 may calculate these values using other information in the profile, such as specific times that the IP address was assigned to each device name and/or each session ended.

The DRR 404 is configured to resolve roles of devices corresponding to device names accessing the network 210 using the information stored in the profiles of the profile database 408. In one example, the profiles may include an additional field identifying a role of a respective device associated with the device names listed in the profiles, and the DRR 404 updates the profiles accordingly. In another example, the profile database 408 or another database may store separate device name profiles correlating each device name to a particular determined role. In still another example, the DRR 404 may determine a role associated with a device name using the information stored in the profile database 408 and communicate the determined roles to other processes, applications, components, etc. of the network 210 (e.g., in response to a query from an IT specialist, a process, etc.).

In one example, the center 400 may include a data collector 412, an IP resolver 416, and an IP address profiler 420. The data collector 412 may be configured to collect information from network traffic as monitored by the gateway 232, and may further collect information from the profile database 408. The IP resolver 416 retrieves the collected information from the data collector 412 to resolve IP addresses to device names as described above with respect to FIGS. 2, 3, and 4. The IP address profiler 420 generates IP address profiles using the resolved IP address and stores the IP address files to the profile database 408. Each of the data collector 412, the IP resolver 416, and the IP address profiler 420 may correspond to hardware executing one or more applications as described above, such as the processor 170 executing one or more DRR and/or NNR server applications 186 stored in the memory 180 as shown in FIG. 1C. In some examples, the DRR 404, the data collector 412, the IP resolver 416, and the IP address profiler 420 may correspond to a same processor 170 configured to execute respective ones of the applications 186.

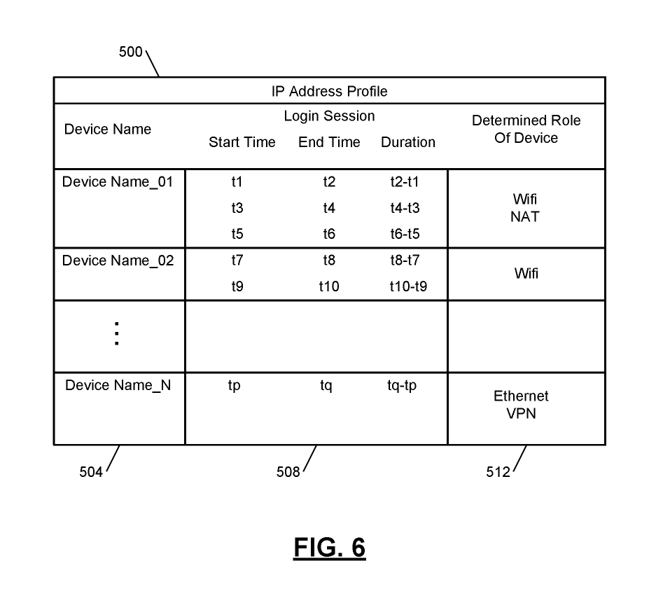

For simplicity, FIG. 6 shows an example IP address profile 500 including a plurality of device names (device names 01, 02, . . . , and N) that were assigned the IP address in a device name field 504, start times, end times, and durations of each login session, in a login session field 508, and a device role, as determined by the DRR 404, for each device name in the profile 500 in a device role field 512. In some examples (e.g., in a NAT topology), the IP address may be assigned to two or more device names in a same or overlapping period. For example only, roles may include, but are not limited to, NAT devices, VPN devices, Wifi or other wireless connections, Ethernet or other wired connections, etc., and/or combinations thereof. Although as shown in the profile 500 the device role specifically identifies roles such as VPN, NAT, Wifi, Ethernet, etc., in other examples the device role may simply include a more general indication of a type of role of the device associated with the device name (e.g., wired vs. wireless, mobile vs. stationary device, a device that shares an IP address with one or more other devices such as in a NAT topology, whether the device is local, remote, or both, etc.).

The DRR 404 determines the device roles using the information in the profile 500 and other profiles for other IP addresses. For example, although only one profile 500 for one IP address is shown, other profiles for other IP addresses may indicate that a particular device name was assigned different IP addresses at different times. Accordingly, to determine the device role associated with a particular device name, the DRR 404 may query and retrieve a plurality of profiles to aggregate information for each IP address assigned to a particular device name. For example, the DRR 404 may search the profile database 408 by device name to retrieve the profiles of each IP address assigned to the device name over a predetermined period of time.

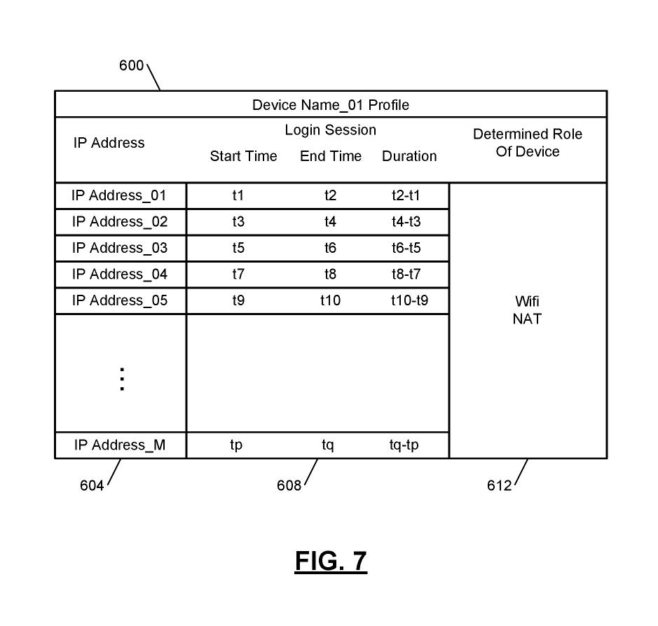

In another example, the DRR 404 generates a device name profile 600 for each device name as shown in FIG. 7. The device name profile 600 indicates every IP address assigned to the device name over a predetermined period of time in an IP address field 400, start times, end times, and durations of each login session with a given one of the IP addresses in a login session field 608, and a device role, as determined by the DRR 404, for the device name in the a device role field 612.

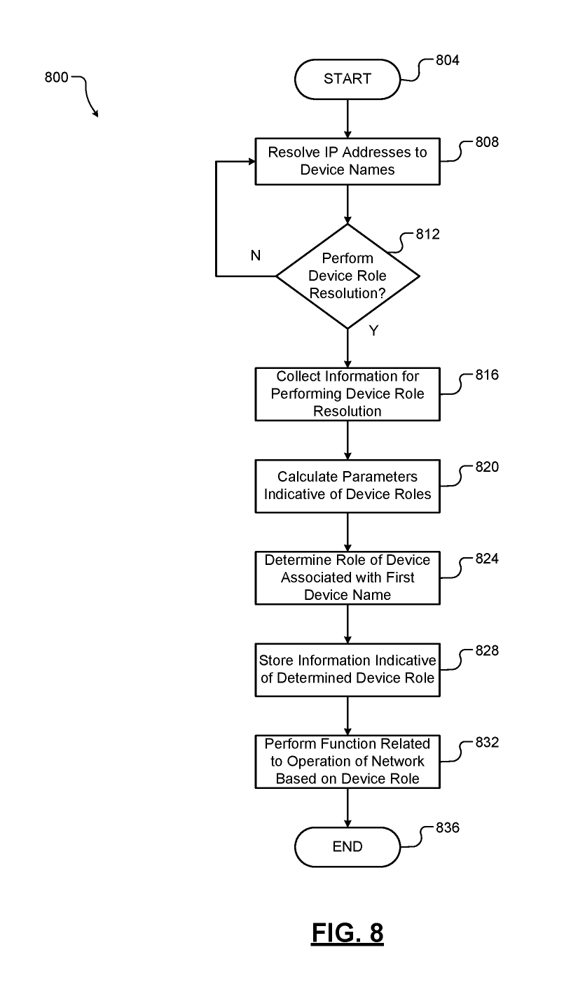

For example only, resolution of a device role associated with a first device name is described with respect to FIGS. 6 and 7, and further with respect to an example method 800 for resolving a device role as shown in FIG. 8. The method 800 starts at 804. At 808, the method 800 resolves IP addresses to device names as described above. For example, at 808 the method 800 may perform IP address to device name resolution as described in steps 304 through 360 of the method 300 of FIGS. 3 and 4. In some examples, the method 800 stores and/or updates respective profiles of the IP addresses. The stored profiles include information correlating the IP addresses to various device names over time.

At 812, the method 800 (e.g., the DRR 404) determines whether to perform device role resolution. For example, the method 800 may perform device role resolution periodically, in response to a query (e.g., a query from a process operating on the network 210, from an IT specialist, etc.), in response to a predetermined condition, etc. If true, the method 800 continues to 816. If false, the method 800 continues to 808.

At 816, the method 800 (e.g., the DRR 404) collects information for performing device role resolution for a selected device name, for a subset of all of the device names in the network 210 (e.g., for only one of the sites 220), for all of the device names in the network 210, etc. For example, the method 800 may perform device role resolution for all of the device names periodically, but may also perform device role resolution for only selected device names in response to a specific query. In one example, to collect information for performing device role resolution for a first device name, the method 800 retrieves information from the stored profiles. For example, the method 800 may retrieve the profile for every IP address that was resolved to the first device name over a predetermined period (e.g., a day, a week, etc.).

At 820, the method 800 (e.g., the DRR 404) calculates various parameters indicative of device roles using the information in the retrieved profiles. For example, the method 800 calculates parameters including, but not limited to, a total number of different IP addresses assigned to the first device name, duration that each IP address was assigned to the first device name, an average duration that each IP address was assigned to the first device name, whether other devices were assigned the same IP address in a same period as the first device name, etc.

At 824, the method 800 (e.g., the DRR 404) determines a role of the device associated with the first device name using the calculated parameters. For example, the method 800 may compare the parameters to respective predetermined thresholds, and determine the role of the device based on whether each parameter exceeds each threshold. In one example, the method 800 determines that the first device name is associated with a WiFi or other wireless device if a number of different IP addresses assigned to the first device name exceeds a threshold (e.g., 10) in a predetermined amount of time (e.g., 1 hour). Conversely, the method 800 may determine that the first device name is associated with an Ethernet or other wired, stationary device if the number of different IP addresses assigned to the first device name does not exceed the threshold, and/or if an average duration that each IP address was assigned to the first device name exceeds a duration threshold. In another example, the method 800 determines that the first device name is associated with a NAT device if the first device name and at least one second device name were each assigned the same IP address during a same period. In this manner, the method 800 determines a role of the device associated with the first device name.

At 828, the method 800 (e.g., the DRR 404) stores information indicating the determined role of the first device name. For example, the method 800 may update each of the IP address profiles that include the first device name to indicate the determined role of the first device name. In some examples, the method 800 may generate and/or update a device name profile for the first device name as described above in FIG. 7.

At 832, the method 800 (e.g., the DRR 404) performs one or more functions related to the operation of the network 210 based on the determined role of the first device name. For example, the method 800 may respond to a query requesting the role of the first device name, display the device name profile, execute, modify, and/or terminate a process associated with the first device name, prevent the first device name from accessing the network 210, notify an IT specialist to investigate the first device name for security purposes, selectively authenticate an entity attempting to access the network 201, etc. The method 800 ends at 836.

The foregoing description is merely illustrative in nature and is in no way intended to limit the disclosure, its application, or uses. The broad teachings of the disclosure can be implemented in a variety of forms. Therefore, while this disclosure includes particular examples, the true scope of the disclosure should not be so limited since other modifications will become apparent upon a study of the drawings, the specification, and the following claims. It should be understood that one or more steps within a method may be executed in different order (or concurrently) without altering the principles of the present disclosure. Further, although each of the embodiments is described above as having certain features, any one or more of those features described with respect to any embodiment of the disclosure can be implemented in and/or combined with features of any of the other embodiments, even if that combination is not explicitly described. In other words, the described embodiments are not mutually exclusive, and permutations of one or more embodiments with one another remain within the scope of this disclosure.

Spatial and functional relationships between elements (for example, between modules, circuit elements, semiconductor layers, etc.) are described using various terms, including “connected,” “engaged,” “coupled,” “adjacent,” “next to,” “on top of,” “above,” “below,” and “disposed.” Unless explicitly described as being “direct,” when a relationship between first and second elements is described in the above disclosure, that relationship can be a direct relationship where no other intervening elements are present between the first and second elements, but can also be an indirect relationship where one or more intervening elements are present (either spatially or functionally) between the first and second elements. As used herein, the phrase at least one of A, B, and C should be construed to mean a logical (A OR B OR C), using a non-exclusive logical OR, and should not be construed to mean “at least one of A, at least one of B, and at least one of C.”

In the figures, the direction of an arrow, as indicated by the arrowhead, generally demonstrates the flow of information (such as data or instructions) that is of interest to the illustration. For example, when element A and element B exchange a variety of information but information transmitted from element A to element B is relevant to the illustration, the arrow may point from element A to element B. This unidirectional arrow does not imply that no other information is transmitted from element B to element A. Further, for information sent from element A to element B, element B may send requests for, or receipt acknowledgements of, the information to element A.

The term memory is a subset of the term computer-readable medium or machine-readable medium. The term computer-readable medium or machine-readable medium, as used herein, does not encompass transitory electrical or electromagnetic signals propagating through a medium (such as on a carrier wave); the term computer-readable medium or machine-readable medium may therefore be considered tangible and non-transitory. Non-limiting examples of a non-transitory, tangible computer-readable medium or machine-readable medium are nonvolatile memory circuits (such as a flash memory circuit, an erasable programmable read-only memory circuit, or a mask read-only memory circuit), volatile memory circuits (such as a static random access memory circuit or a dynamic random access memory circuit), magnetic storage media (such as an analog or digital magnetic tape or a hard disk drive), and optical storage media (such as a CD, a DVD, or a Blu-ray Disc).

In this application, apparatus elements described as having particular attributes or performing particular operations are specifically configured to have those particular attributes and perform those particular operations. Specifically, a description of an element to perform an action means that the element is configured to perform the action. The configuration of an element may include programming of the element, such as by encoding instructions on a non-transitory, tangible computer-readable medium associated with the element.

The apparatuses and methods described in this application may be partially or fully implemented by a special purpose computer created by configuring a general purpose computer to execute one or more particular functions embodied in computer programs. The functional blocks, flowchart components, and other elements described above serve as software specifications, which can be translated into the computer programs by the routine work of a skilled technician or programmer.

The computer programs include processor-executable instructions that are stored on at least one non-transitory, tangible computer-readable medium. The computer programs may also include or rely on stored data. The computer programs may encompass a basic input/output system (BIOS) that interacts with hardware of the special purpose computer, device drivers that interact with particular devices of the special purpose computer, one or more operating systems, user applications, background services, background applications, etc.

The computer programs may include: (i) descriptive text to be parsed, such as HTML (hypertext markup language), XML (extensible markup language), or JSON (JavaScript Object Notation) (ii) assembly code, (iii) object code generated from source code by a compiler, (iv) source code for execution by an interpreter, (v) source code for compilation and execution by a just-in-time compiler, etc. As examples only, source code may be written using syntax from languages including C, C++, C#, Objective-C, Swift, Haskell, Go, SQL, R, Lisp, Java®, Fortran, Perl, Pascal, Curl, OCaml, Javascript®, HTML5 (Hypertext Markup Language 5th revision), Ada, ASP (Active Server Pages), PHP (PHP: Hypertext Preprocessor), Scala, Eiffel, Smalltalk, Erlang, Ruby, Flash®, Visual Basic®, Lua, MATLAB, SIMULINK, and Python®.

None of the elements recited in the claims are intended to be a means-plus-function element within the meaning of 35 U.S.C. § 112(f) unless an element is expressly recited using the phrase “means for,” or in the case of a method claim using the phrases “operation for” or “step for.”

What is claimed is:

1. A system comprising:
a gateway to monitor traffic from a plurality of devices accessing a network;
a data collector to collect first information from the traffic monitored by the gateway;
an Internet Protocol (IP) resolver to resolve addresses to a plurality of device names using the collected first information, wherein each of the plurality of device names is associated with a respective one of the plurality of devices, and wherein resolving the IP addresses includes identifying which of the plurality of device names was assigned each of the IP addresses;
an IP address profiler to generate respective IP address profiles for each of the IP addresses, wherein each of the IP address profiles includes second information identifying (i) which of the plurality of device names were assigned a respective one of the IP addresses in a login session and (ii) at least one characteristic of the login session, wherein the data collector is further to collect third information from at least one of the IP address profiles; and
a device role resolver to, using the third information collected from the at least one of the IP address profiles, (i) determine a role of a first device of the plurality of devices that is associated with a first device name of the plurality of device names, and (ii) store fourth information identifying the determined role of the first device.

2. The system of claim 1, wherein the role of the first device corresponds to an indication of at least one of (i) whether the first device is a network address translation device, (ii) whether the first device is a virtual private network device, and (iii) whether the first device accesses the network using a wired or wireless connection.

3. The system of claim 1, wherein the at least one characteristic of the login session includes a timeline of the login session.

4. The system of claim 3, wherein the timeline of the login session includes a first time that the login session started and a second time that the login session ended.

5. The system of claim 1, wherein, to use the third information collected from the at least one of the IP address profiles to determine the role of a first device, the device role resolver is further to calculate at least one parameter indicative of the role of the first device using the third information.

6. The system of claim 5, wherein the at least one parameter includes at least one of (i) a total number of different IP addresses assigned to the first device name, (ii) a duration that each one of the different IP addresses was assigned to the first device name, (iii) an average duration that each of the different IP addresses was assigned to the first device name, and (iv) whether a same one of the different IP addresses was assigned to a second device name of the plurality of device names in a same period as the first device name.

7. The system of claim 6, wherein, to determine the role of the first device, the device role resolver is further to compare the at least one parameter to a threshold and determine the role of the first device based on the comparison.

8. The system of claim 1, wherein, to store the fourth information identifying the determined role of the first device, the device role resolver is further to update the at least one of the IP address profiles to include the determined role of the first device.

9. The system of claim 1, wherein, to store the fourth information identifying the determined role of the first device, the device role resolver is further to generate a device name profile identifying the determined role of the first device.

10. The system of claim 1, further comprising a profile database to store at least one of the IP address profiles and the fourth information identifying the determined role of the first device.

11. A method comprising:
monitoring traffic from a plurality of devices accessing a network;
collecting first information from the monitored traffic;
resolving Internet Protocol (IP) addresses to a plurality of device names using the collected first information, wherein each of the plurality of device names is associated with a respective one of the plurality of devices, and wherein resolving the IP addresses includes identifying which of the plurality of device names was assigned each of the IP addresses;
generating respective IP address profiles for each of the IP addresses, wherein each of the IP address profiles includes second information identifying (i) which of the plurality of device names were assigned a respective one of the IP addresses in a login session and (ii) at least one characteristic of the login session;
collecting third information from at least one of the IP address profiles;
using the third information collected from the at least one of the IP address profiles, determining a role of a first device of the plurality of devices that is associated with a first device name of the plurality of device names; and
storing fourth information identifying the determined role of the first device.

12. The method of claim 11, wherein the role of the first device corresponds to an indication of at least one of (i) whether the first device is a network address translation device, (ii) whether the first device is a virtual private network device, and (iii) whether the first device accesses the network using a wired or wireless connection.

13. The method of claim 11, wherein the at least one characteristic of the login session includes a timeline of the login session.

14. The method of claim 13, wherein the timeline of the login session includes a first time that the login session started and a second time that the login session ended.

15. The method of claim 11, wherein, using the third information collected from the at least one of the IP address profiles to determine the role of a first device includes calculating at least one parameter indicative of the role of the first device using the third information.

16. The method of claim 15, wherein the at least one parameter includes at least one of (i) a total number of different IP addresses assigned to the first device name, (ii) a duration that each one of the different IP addresses was assigned to the first device name, (iii) an average duration that each of the different IP addresses was assigned to the first device name, and (iv) whether a same one of the different IP addresses was assigned to a second device name of the plurality of device names in a same period as the first device name.

17. The method of claim 16, wherein determining the role of the first device includes comparing the at least one parameter to a threshold and determining the role of the first device based on the comparison.

18. The method of claim 11, wherein storing the fourth information identifying the determined role of the first device includes updating the at least one of the IP address profiles to include the determined role of the first device.

19. The method of claim 11, wherein storing the fourth information identifying the determined role of the first device includes generating a device name profile identifying the determined role of the first device.

20. A gateway for a distributed network system, the gateway comprising:
a processor;
a tangible machine readable medium storing machine readable instructions that, when executed by the processor, configure the gateway to
monitor traffic from a plurality of devices accessing the distributed network system,
collect first information from monitored traffic,
resolve Internet Protocol (IP) addresses to a plurality of device names using the collected first information, wherein each of the plurality of device names is associated with a respective one of the plurality of devices, and wherein resolving the IP addresses includes identifying which of the plurality of device names was assigned each of the IP addresses,
generate respective IP address profiles for each of the IP addresses, wherein each of the IP address profiles includes second information identifying (i) which of the plurality of device names were assigned a respective one of the IP addresses in a login session and (ii) at least one characteristic of the login session,
collecting third information from at least one of the IP address profiles,
using the third information collected from the at least one of the IP address profiles, determine a role of a first device of the plurality of devices that is associated with a first device name of the plurality of device names, and
store fourth information identifying the determined role of the first device; and
a profile database to store the IP address profiles and the fourth information identifying the determined role of the first device.
